(19) United States
(12) Patent Application Publication
(10) Pub. No.: US 2026/0353516 A1
(43) Pub. Date: Nov. 5, 2026

(54) SHEET-SHAPED HEATER

(71) Applicant: TOMOEGAWA CORPORATION, Tokyo (JP)

(72) Inventors: Makoto GOTO, Shizuoka-shi (JP); Yosuke SUGAWARA, Shizuoka (JP); Tetsuya YAMADA, Shizuoka (JP)

(21) Appl. No.: 19/485,877

(22) PCT Filed: May 8, 2024
(86) PCT No.: PCT/JP2024/017165

§ 371 Date: Nov. 19, 2025

(30) Foreign Application Priority Data
Jun. 2, 2023 (JP) 2023-091715

(51) Int. Cl. H05B 3/28; H05B 3/03

(52) U.S. Cl. CPC H05B 3/286; H05B 3/03; H05B 2203/003

(57) ABSTRACT

A sheet-shaped heater includes: an X portion including a first insulating layer, a first adhesive layer, a heat generating layer, a second adhesive layer, and a second insulating layer; a Y portion inside the X portion and including the first insulating layer, the first adhesive layer, a first bonding auxiliary layer, the heat generating layer, the second adhesive layer, and the second insulating layer; and a Z portion inside the Y portion and including the first bonding auxiliary layer, the heat generating layer, the second adhesive layer, and the second insulating layer, and not the first insulating layer and first adhesive layer. The first bonding auxiliary layer has an electrode. The heater has a bonding part comprising part of each of the heat generating layer, first bonding auxiliary layer, and electrode. At least part of a slit of the first bonding auxiliary layer is inside the Y and/or Z portion.

### CROSS REFERENCE TO RELATED APPLICATIONS

This application is a 371 U.S. National Phase of International Application No. PCT/JP2024/017165, filed on May 8, 2024, which claims priority to Japanese Patent Application No. 2023-091715, filed on Jun. 2, 2023. The entire disclosures of the above applications are incorporated herein by reference.

### BACKGROUND

### Technical Field

The present invention relates to a sheet-shaped heater.

### Related Art

Several sheet-shaped heaters have heretofore been proposed.

JP 3127850 Y (Patent Document 1) describes a planar heater including: a plurality of laminar stainless steel heating elements disposed in parallel and an insulating base material superimposed on at least one surface of each of these heating elements, wherein an electric power entry terminal is fixed to one end of each of the heating elements, and a connecting portion for connecting one of the heating elements to its neighboring heating element is formed at the other end by overlaying filler metal on a terminal strip.

In a sheet-shaped heater, an insulating layer is preferably closely attached to a heat-generating layer through an adhesion layer over a wide area because the insulation properties of the sheet-shaped heater are increased as a whole.

The present invention provides a sheet-shaped heater including an insulating layer closely attached to a heat-generating layer through an adhesion layer over a wide area and hence having high insulation properties as a whole.

### SUMMARY

The inventors of the present invention have made an intensive study to solve the problem described above and completed the present invention.

The present invention provides the following (1) to (12).
(1) A sheet-shaped heater including:
   a portion X in which
   a first insulating layer,
   a first adhesion layer,
   a heat-generating layer,
   a second adhesion layer, and
   a second insulating layer
are stacked in this order;
   a portion Y which is present inside the portion X so as to be adjacent to the portion X when a main surface is seen from its perpendicular line direction, and in which
   the first insulating layer,
   the first adhesion layer,
   a first joining auxiliary layer,
   the heat-generating layer,
   the second adhesion layer, and
   the second insulating layer
are stacked in this order; and
   a portion Z which is present inside the portion Y so as to be adjacent to the portion Y when the main surface is further seen from its perpendicular line direction, in which
   the first joining auxiliary layer,
   the heat-generating layer,
   the second adhesion layer, and
   the second insulating layer
are stacked in this order, and which does not include the first insulating layer or the first adhesion layer, wherein:
   the first insulating layer at the portion X and the portion Y is an integral part,
   the first joining auxiliary layer at the portion Y and the portion Z is an integral part,
   each of the heat-generating layer and the second insulating layer at the portion X, the portion Y, and the portion Z is an integral part,
   an electrode is present on a main surface of the first joining auxiliary layer which is on a side farther away from the heat-generating layer,
   the sheet-shaped heater has a joining portion made up of at least a part of each of the heat-generating layer, the first joining auxiliary layer, and the electrode, and the joining portion electrically connects the heat-generating layer, the first joining auxiliary layer and the electrode to each other, and
   the first joining auxiliary layer has slits, at least parts thereof being present within the portion Y and/or the portion Z.
(2) The sheet-shaped heater according to (1) above, satisfying α>β₁ where α is a thickness of the first adhesion layer and β₁ is a total thickness of the first joining auxiliary layer and the heat-generating layer.
(3) The sheet-shaped heater according to (1) or (2) above, wherein at least a part of each of the heat-generating layer, the first joining auxiliary layer, and the electrode is melted by heating and then solidified to form the joining portion.
(4) The sheet-shaped heater according to (1) or (2) above, further including:
   a second joining auxiliary layer, at least a part thereof being present within the portion Z between the heat-generating layer and the second adhesion layer,
   wherein the joining portion is made up of at least a part of each of the second joining auxiliary layer, the heat-generating layer, the first joining auxiliary layer, and the electrode.
(5) The sheet-shaped heater according to (4) above, satisfying α>β₂ where α is a thickness of the first adhesion layer and β₂ is a total thickness of the first joining auxiliary layer, the heat-generating layer, and the second joining auxiliary layer.
(6) The sheet-shaped heater according to (4) or (5) above, wherein at least a part of each of the second joining auxiliary layer, the heat-generating layer, the first joining auxiliary layer, and the electrode is melted by heating and then solidified to form the joining portion.
(7) The sheet-shaped heater according to (1) or (2) above, further including:
   at least a part of a third joining auxiliary layer coming into contact with a portion of the electrode which is within the portion Z and is not in contact with the first joining auxiliary layer,
   wherein the joining portion is made up of at least a part of each of the heat-generating layer, the first joining auxiliary layer, the electrode, and the third joining auxiliary layer.
(8) The sheet-shaped heater according to (7) above, satisfying α>β₁ where α is a thickness of the first adhesion layer and β₁ is a total thickness of the first joining auxiliary layer and the heat-generating layer.
(9) The sheet-shaped heater according to (7) or (8) above, wherein at least a part of each of the heat-generating layer, the first joining auxiliary layer, the electrode, and the third joining auxiliary layer is melted by heating and then solidified to form the joining portion.
(10) The sheet-shaped heater according to (4) above, further including:
   at least a part of a third joining auxiliary layer coming into contact with a portion of the electrode which is within the portion Z and is not in contact with the first joining auxiliary layer,
   wherein the joining portion is made up of at least a part of each of the second joining auxiliary layer, the heat-generating layer, the first joining auxiliary layer, the electrode, and the third joining auxiliary layer.
(11) The sheet-shaped heater according to (10) above, satisfying α>β₂ where α is a thickness of the first adhesion layer and β₂ is a total thickness of the first joining auxiliary layer, the heat-generating layer, and the second joining auxiliary layer.
(12) The sheet-shaped heater according to (10) or (11) above, wherein at least a part of each of the second joining auxiliary layer, the heat-generating layer, the first joining auxiliary layer, the electrode, and the third joining auxiliary layer is melted by heating and then solidified to form the joining portion.

### EFFECT OF THE INVENTION

The present invention can provide a sheet-shaped heater including an insulating layer closely attached to a heat-generating layer through an adhesion layer over a wide area and hence having high insulation properties as a whole.

### BRIEF DESCRIPTION OF THE DRAWINGS

FIG. 1 is a schematic view illustrating a case where a main surface of a sheet-shaped heater of the invention is seen from its perpendicular line direction.

FIG. 2 is a cross-sectional view (schematic view) taken along line A-A in FIG. 1.

FIGS. 3A to 3G are schematic views illustrating main surfaces of several types of first joining auxiliary layers 13 having different slit forms.

FIG. 4 is a schematic cross-sectional view showing a preferred embodiment of the sheet-shaped heater of the invention.

FIG. 5 is an SEM image obtained by using a scanning electron microscope (SEM) on a cross-section of the sheet-shaped heater 1 of the invention shown in FIG. 4 in the vicinity of a joining portion 17.

FIG. 6 is a schematic cross-sectional view showing another preferred embodiment of the sheet-shaped heater of the invention.

FIG. 7 is a schematic cross-sectional view showing still another preferred embodiment of the sheet-shaped heater of the invention.

FIG. 8 is a view (schematic cross-sectional view) for illustrating a manufacturing method of the invention.

FIG. 9 is another view (schematic cross-sectional view) for illustrating the manufacturing method of the invention.

FIG. 10 is still another view (schematic cross-sectional view) for illustrating the manufacturing method of the invention.

FIG. 11 is still another view (schematic cross-sectional view) for illustrating the manufacturing method of the invention.

FIG. 12 is still another view (schematic cross-sectional view) for illustrating the manufacturing method of the invention.

FIG. 13 is still another view (schematic cross-sectional view) for illustrating the manufacturing method of the invention.

### DETAILED DESCRIPTION

The present invention will be described.

The present invention provides a sheet-shaped heater including: a portion X in which a first insulating layer, a first adhesion layer, a heat-generating layer, a second adhesion layer, and a second insulating layer are stacked in this order; a portion Y which is present inside the portion X so as to be adjacent to the portion X when a main surface is seen from its perpendicular line direction, and in which the first insulating layer, the first adhesion layer, a first joining auxiliary layer, the heat-generating layer, the second adhesion layer, and the second insulating layer are stacked in this order; and a portion Z which is present inside the portion Y so as to be adjacent to the portion Y when the main surface is further seen from its perpendicular line direction, in which the first joining auxiliary layer, the heat-generating layer, the second adhesion layer, and the second insulating layer are stacked in this order, and which does not include the first insulating layer or the first adhesion layer, wherein: the first insulating layer at the portion X and the portion Y is an integral part, the first joining auxiliary layer at the portion Y and the portion Z is an integral part, each of the heat-generating layer and the second insulating layer at the portion X, the portion Y, and the portion Z is an integral part, an electrode is present on a main surface of the first joining auxiliary layer which is on a side farther away from the heat-generating layer, the sheet-shaped heater has a joining portion made up of at least a part of each of the heat-generating layer, the first joining auxiliary layer, and the electrode, and the joining portion electrically connects the heat-generating layer, the first joining auxiliary layer and the electrode to each other, and the first joining auxiliary layer has slits, at least parts thereof being present within the portion Y and/or the portion Z.

Such a sheet-shaped heater is hereinafter referred to also as the “sheet-shaped heater of the invention.”

The sheet-shaped heater of the invention will be described using drawings.

Every drawing to be used below shows an example of the sheet-shaped heater of the invention, and the sheet-shaped heater of the invention is not limited to embodiments shown in the drawings. For ease of understanding, the drawings are shown schematically and may be different in scale from preferred embodiments.

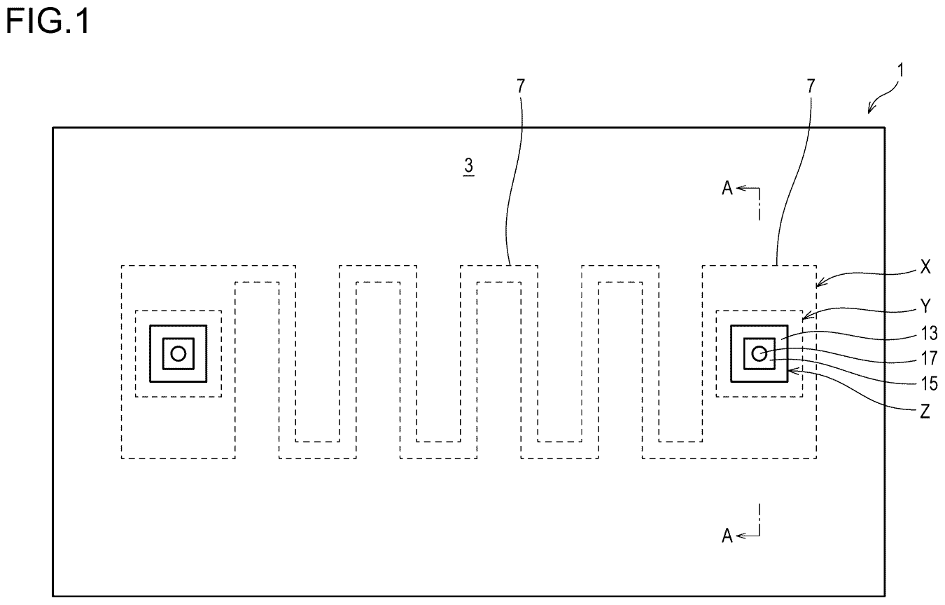

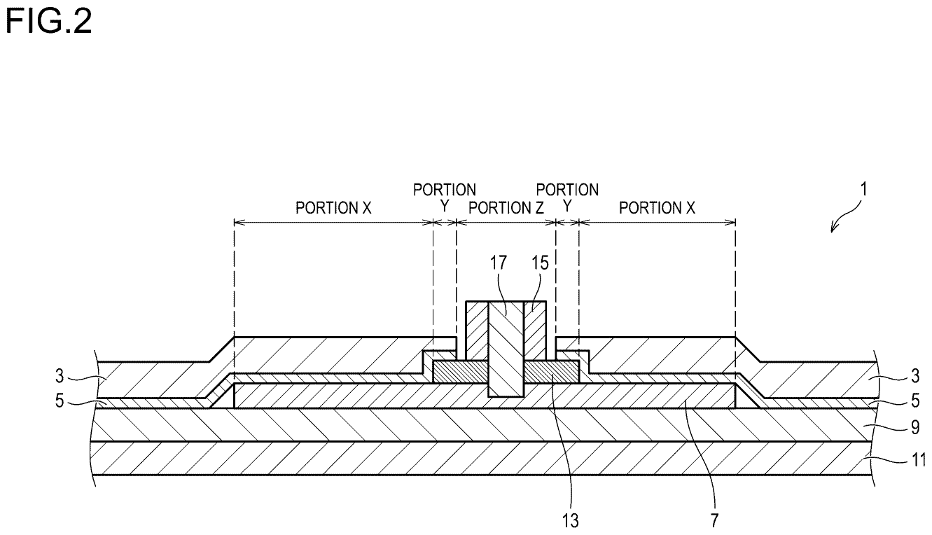

FIG. 1 is a schematic view of a main surface of a sheet-shaped heater of the invention as seen from its perpendicular line direction. FIG. 2 is a cross-sectional view (schematic view) taken along line A-A in FIG. 1.

In principle, a heat-generating layer is not exposed at the uppermost surface of the sheet-shaped heater of the invention and positions where the heat-generating layer is present are shown by dotted lines in FIG. 1. The dotted lines also represent the outer edge of a portion X. The portion X is a portion other than portions Y and Z, which includes the heat-generating layer at any position of the sheet-shaped heater of the invention in its thickness direction.

Usually, not all the parts of a first joining auxiliary layer but only a part thereof appears at the uppermost surface of the sheet-shaped heater of the invention, and FIG. 1 shows its outer edge by dotted lines. The portion Y is inside the dotted lines and outside the portion Z.

As shown in FIG. 1, when a main surface of a sheet-shaped heater 1 of the invention is seen from its perpendicular line direction, it includes the portion X, and the portion Y in its interior, and the portion Z in its further interior.

The portion Y is present next to the portion X, and the portion Z is present next to the portion Y.

As shown in FIG. 2, the portion X is a portion where a first insulating layer 3, a first adhesion layer 5, a heat-generating layer 7, a second adhesion layer 9, and a second insulating layer 11 are stacked in this order.

As shown in FIG. 2, the portion Y is a portion where the first insulating layer 3, the first adhesion layer 5, a first joining auxiliary layer 13, the heat-generating layer 7, the second adhesion layer 9, and the second insulating layer 11 are stacked in this order.

As shown in FIG. 2, the portion Z is a portion where the first joining auxiliary layer 13, the heat-generating layer 7, the second adhesion layer 9, and the second insulating layer 11 are stacked in this order.

The portion Z does not have the first insulating layer 3 and the first adhesion layer 5. At the boundary between the portion Z and the portion Y, however, a narrow region where only one of the first insulating layer 3 and the first adhesion layer 5 is present may be further present on the upper surface of the first joining auxiliary layer 13 at the portion Z. In such a case, the region is considered to be included in the portion Y.

The first insulating layer 3 at the portion X and the portion Y is an integral part.

The first insulating layer 3 at a portion outside the portion X in a case where the main surface of the sheet-shaped heater 1 of the invention is seen from its perpendicular line direction, and at the portion X and the portion Y is also preferably an integral part.

The first adhesion layer 5 at the portion X and the portion Y is also preferably an integral part.

The first adhesion layer 5 at the portion outside the portion X in a case where the main surface of the sheet-shaped heater 1 of the invention is seen from its perpendicular line direction, and at the portion X and the portion Y is also preferably an integral part.

The first joining auxiliary layer 13 at the portion Y and the portion Z is an integral part.

Each of the heat-generating layer 7 and the second insulating layer 11 at the portion X, the portion Y, and the portion Z is an integral part.

The second insulating layer 11 at the portion outside the portion X in a case where the main surface of the sheet-shaped heater 1 of the invention is seen from its perpendicular line direction, and at the portion X, the portion Y, and the portion Z is also preferably an integral part.

The second adhesion layer 9 at the portion X, the portion Y, and the portion Z is also preferably an integral part.

Further, the second adhesion layer 9 at the portion outside the portion X in a case where the sheet-shaped heater 1 of the invention is seen from its perpendicular line direction, and at the portion X, the portion Y, and the portion Z is also preferably an integral part.

The expression “an integral part” means an aspect in which an element is not separated but can be recognized as a single object.

For example, in a case where an adhesive sheet is used as the first adhesion layer 5, if the first adhesion layer 5 at the portion X and the portion Y is made of a single adhesive sheet, this corresponds to an aspect in which the first adhesion layer 5 is an integral part.

For example, in a case where a metal fiber sheet is used as the heat-generating layer 7, if the heat-generating layer 7 at the portion X, the portion Y, and the portion Z is made of a single metal fiber sheet, this corresponds to an aspect in which the heat-generating layer 7 is an integral part.

For example, when an insulating sheet is used as the second insulting layer 11, if the second insulating layer 11 at the portion outside the portion X in a case where the main surface of the sheet-shaped heater 1 of the invention is seen from its perpendicular line direction, and at the portion X, the portion Y, and the portion Z is made of a single insulating sheet, this corresponds to an aspect in which the second insulating layer 11 is an integral part.

The sheet-shaped heater 1 of the invention further has an electrode 15 on one of two main surfaces of the first joining auxiliary layer 13 which is on the side farther away from the heat-generating layer 7.

The electrode 15 may not be in contact with the main surface of the first joining auxiliary layer 13. For example, another layer such as an adhesive layer may be present between the electrode 15 and the first joining auxiliary layer 13. However, the first joining auxiliary layer 13 and the electrode 15 are preferably in contact with each other.

The electrode 15 can be electrically connected to an external power source.

The sheet-shaped heater 1 of the invention has a joining portion 17 for electrically connecting the heat-generating layer 7, the first joining auxiliary layer 13, and the electrode 15 to each other.

The joining portion 17 is made up of at least a part of each of the heat-generating layer 7, the first joining auxiliary layer 13, and the electrode 15. Specifically, at least a part of each of the heat-generating layer 7, the first joining auxiliary layer 13, and the electrode 15 is preferably melted by heating and then solidified to form the joining portion 17. The joining portion 17 may be made up of at least a part of still another layer in addition to the above.

Further preferably, at least a part of each of members making up the joining portion 17 (heat-generating layer 7, first joining auxiliary layer 13, and electrode 15) is simultaneously melted by heating and then solidified to form the joining portion 17.

An example of the heating method is, but is not limited to, welding. When the electrode 15 is welded to the surface of the first joining auxiliary layer 13, generated heat allows not only at least a part of each of the electrode 15 and the first joining auxiliary layer 13 but also a part of the heat-generating layer 7 to be melted. After that, the joining portion 17 can be formed by solidifying the melted members through cooling.

In the sheet-shaped heater 1 of the invention, the first joining auxiliary layer 13 has slits.

However, by forming the joining portion 17 as described above, at least parts of the slits may be lost, or something that cannot be defined as a slit, as exemplified by a hole, may be formed.

Therefore, each slit included in the first joining auxiliary layer 13 has a concept including a slit itself, that is, a cut which reaches one main surface of the first joining auxiliary layer 13 from the other main surface thereof, and something like a hole which was a slit before forming the joining portion 17 but does not have a slit shape due to formation of the joining portion 17, that is, a hole derived from a slit.

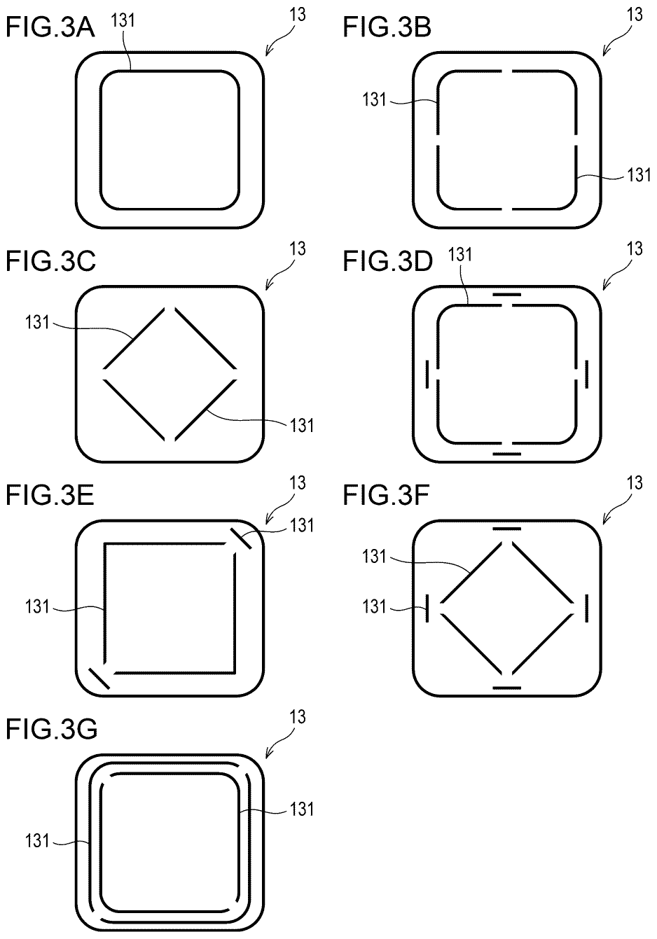

The slits included in the first joining auxiliary layer 13 will be described using FIG. 3.

FIGS. 3A to 3G are schematic views illustrating main surfaces of several types of first joining auxiliary layers 13.

As described above, before the joining portion 17 is formed, the first joining auxiliary layer 13 has slits 131 as shown in, for example, FIGS. 3A to 3G.

Each of the first joining auxiliary layers 13 illustrated in FIGS. 3A to 3G has the slits 131. Each slit 131 is a cut that reaches one main surface of the first joining auxiliary layer 13 from the other main surface thereof. The method of forming the slits 131 is not particularly limited and they can be formed, for example, using a box cutter.

In the first joining auxiliary layer 13, at least a part of and preferably the whole of each slit 131 is present within the portion Y and/or the portion Z in the first joining auxiliary layer 13.

In the first joining auxiliary layer 13, preferably at least a part of and more preferably the whole of each slit 131 is present within the portion Z in the first joining auxiliary layer 13. That is, preferably at least a part of and more preferably the whole of each slit 131 is present at a portion of the first joining auxiliary layer 13 which is not in contact with the first adhesion layer 5.

Preferably at least a part of and more preferably the whole of each slit 131 is present at a portion of the first joining auxiliary layer 13 located within the portion Y and/or the portion Z and outside the joining portion 17. Each of the first joining auxiliary layers 13 in the embodiments shown in FIGS. 3A to 3G may correspond to a layer having such slits.

Preferably at least a part of and more preferably the whole of each slit 131 is present at a portion of the first joining auxiliary layer 13 located within the portion Z and outside the joining portion 17. That is, preferably at least a part of each slit 131 is present at a portion of the first joining auxiliary layer 13 which is not in contact with the first adhesion layer 5 and outside the joining portion 17. Each of the first joining auxiliary layers 13 in the embodiments shown in FIGS. 3A to 3G may correspond to a layer having such slits.

For example, when the electrode 15 is welded to a surface of the first joining auxiliary layer 13, generated heat deforms the first joining auxiliary layer 13. However, the first joining auxiliary layer 13 of the sheet-shaped heater 1 of the invention has the slits 131 within the portion Y and/or the portion Z, and hence deformation is less likely to affect the first insulating layer 3. Therefore, the first insulating layer 3 is closely attached to the heat-generating layer 7 through the first adhesion layer 5 over a wide area to increase the insulation properties of the sheet-shaped heater 1 of the invention as a whole.

In contrast, if the first joining auxiliary layer 13 has no slit or slits included therein are not present within the portion Y or the portion Z, when the electrode 15 is welded to the surface of the first joining auxiliary layer 13 and generated heat deforms the first joining auxiliary layer 13, the deformation affects the first insulating layer 3, which is less likely to be closely attached to the heat-generating layer 7 through the first adhesion layer 5. As a result, tunneling may occur.

The tunneling means a state in which, as a result of a reduced degree of attachment of the first insulating layer 3 to the heat-generating layer 7 through the first adhesion layer 5, voids are generated between the first insulating layer 3 and the first adhesion layer 5, or between the first adhesion layer 5 and the heat-generating layer 7 to form something like a passage (tunnel).

The sheet-shaped heater 1 of the invention preferably satisfies α>β₁ where α is the thickness of the first adhesion layer 5 and β₁ is the total thickness of the first joining auxiliary layer 13 and the heat-generating layer 7.

This is because, in this case, the first insulating layer 3 is closely attached to the heat-generating layer 7 through the first adhesion layer 5 over a wider area to further increase the insulation properties of the sheet-shaped heater 1 of the invention as a whole.

The thickness of each of the first adhesion layer 5, the first joining auxiliary layer 13, and the heat-generating layer 7 is determined as follows:

An optical microscope is used to obtain a magnified image (200×) of a cross-section as shown in FIG. 2 in a direction perpendicular to a main surface of a sheet-shaped heater of the invention, and thereafter on the magnified image, the thickness of each layer is measured at randomly selected 100 points and its simple average value is determined. Then, the resulting average value is taken as the thickness of the corresponding layer.

Each of the thicknesses of the other layers to be described later is also represented by a value obtained through measurement using the same method.

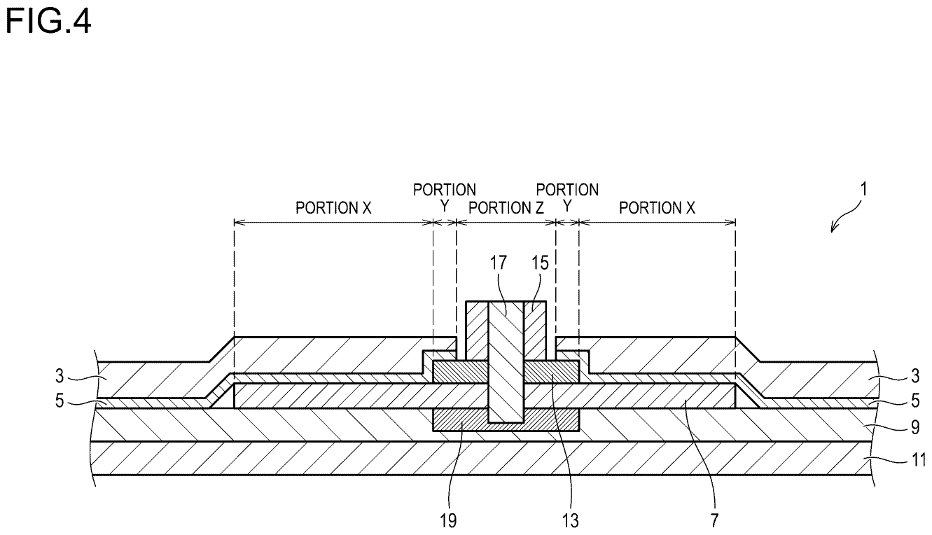

As shown in FIG. 4, the sheet-shaped heater 1 of the invention preferably has a second joining auxiliary layer 19 between the heat-generating layer 7 and the second adhesion layer 9, at least a part of the second joining auxiliary layer 19 being present within the portion Z.

As shown in FIG. 4, the sheet-shaped heater 1 of the invention more preferably has the second joining auxiliary layer 19 between the heat-generating layer 7 and the second adhesion layer 9, the whole of the second joining auxiliary layer 19 being present within the portion Y and the portion Z.

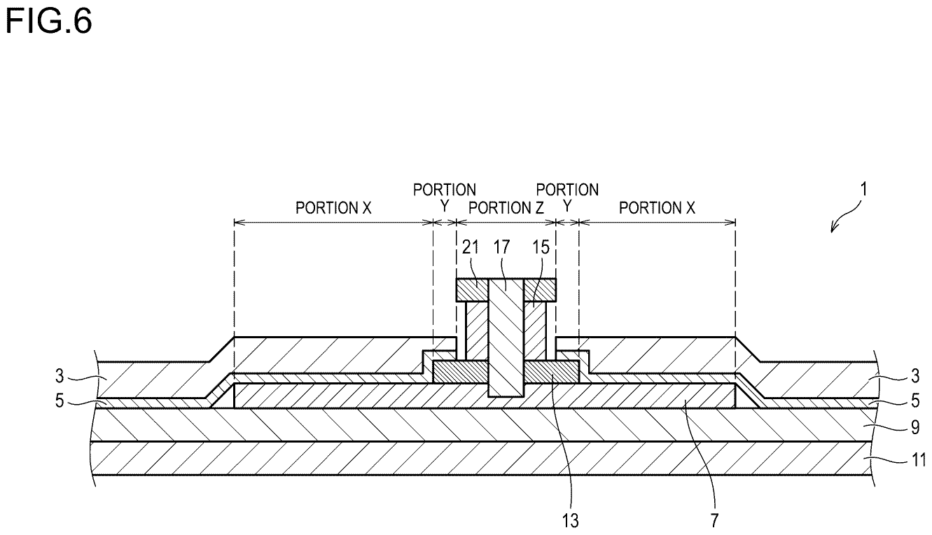

As in FIG. 2, FIG. 4 is a cross-sectional view of the sheet-shaped heater 1 of the invention in a direction perpendicular to its main surface. In FIG. 4, unless otherwise specified, the same elements are denoted by the same symbols as in FIG. 2. The same applies to FIG. 6 to FIG. 13.

In this preferred embodiment, the joining portion 17 is made up of at least a part of each of the second joining auxiliary layer 19, the heat-generating layer 7, the first joining auxiliary layer 13, and the electrode 15. Specifically, at least a part of each of the second joining auxiliary layer 19, the heat-generating layer 7, the first joining auxiliary layer 13, and the electrode 15 is preferably melted by heating and then solidified to form the joining portion 17. The joining portion 17 may be made up of at least a part of still another layer in addition to the above.

In this preferred embodiment, at least a part of each of the second joining auxiliary layer 19, the heat-generating layer 7, the first joining auxiliary layer 13, and the electrode 15 is more preferably melted simultaneously by heating and then solidified to form the joining portion 17.

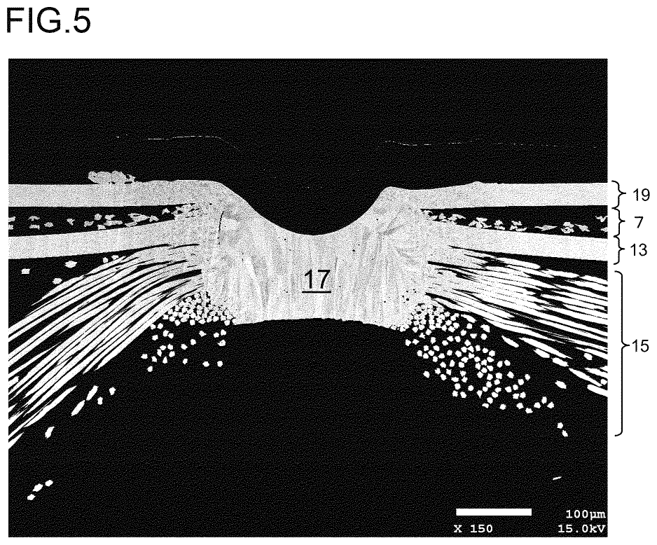

A cross-section of the sheet-shaped heater 1 of the invention shown in FIG. 4 in the vicinity of the joining portion 17 is illustrated in FIG. 5. FIG. 5 is an SEM image obtained by using a scanning electron microscope (SEM) on the cross-section of the sheet-shaped heater 1 of the invention shown in FIG. 4 in the vicinity of the joining portion 17.

It can be seen from FIG. 5 that at least a part of each of the electrode 15, the first joining auxiliary layer 13, the heat-generating layer 7, and the second joining auxiliary layer 19 is melted and then solidified to form the joining portion 17 which extends in the thickness direction.

The second joining auxiliary layer 19 may be of the type having slits as in the first joining auxiliary layer 13.

When the second joining auxiliary layer 19 has slits, they may be the same as those included in the first joining auxiliary layer 13 as for the aspect including positions of the slits.

The sheet-shaped heater 1 of the invention in the embodiment shown in FIG. 4 preferably satisfies α>β₂ where α is the thickness of the first adhesion layer 5 and β₂ is the total thickness of the first joining auxiliary layer 13, the heat-generating layer 7, and the second joining auxiliary layer 19.

This is because, in this case, the first insulating layer 3 is closely attached to the heat-generating layer 7 through the first adhesion layer 5 over a wider area to further increase the insulation properties of the sheet-shaped heater 1 of the invention as a whole.

As shown in FIG. 6, the sheet-shaped heater 1 of the invention preferably has at least a part of (and preferably the whole of) a third joining auxiliary layer 21 at a portion of the electrode 15 which is within the portion Z and is not in contact with the first joining auxiliary layer 13.

As in FIG. 2, FIG. 6 is a cross-sectional view of the sheet-shaped heater 1 of the invention in a direction perpendicular to its main surface.

In this preferred embodiment, the joining portion 17 is made up of at least a part of each of the heat-generating layer 7, the first joining auxiliary layer 13, the electrode 15, and the third joining auxiliary layer 21. Specifically, at least a part of each of the heat-generating layer 7, the first joining auxiliary layer 13, the electrode 15, and the third joining auxiliary layer 21 is preferably melted by heating and then solidified to form the joining portion 17. The joining portion 17 may be made up of at least a part of still another layer in addition to the above.

In this preferred embodiment, at least a part of each of the heat-generating layer 7, the first joining auxiliary layer 13, the electrode 15, and the third joining auxiliary layer 21 is more preferably melted simultaneously by heating and then solidified to form the joining portion 17.

In this case, the electrode 15 can be strongly bonded to the first joining auxiliary layer 13.

The third joining auxiliary layer 21 may be of the type having slits as in the first joining auxiliary layer 13.

When the third joining auxiliary layer 21 has slits, they may be the same as those included in the first joining auxiliary layer 13 as for the aspect including positions of the slits.

The sheet-shaped heater 1 of the invention in the embodiment shown in FIG. 6 also preferably satisfies α>β₁ where α is the thickness of the first adhesion layer 5 and β₁ is the total thickness of the first joining auxiliary layer 13 and the heat-generating layer 7.

This is because, in this case, the first insulating layer 3 is closely attached to the heat-generating layer 7 through the first adhesion layer 5 over a wide area to further increase the insulation properties of the sheet-shaped heater 1 of the invention as a whole.

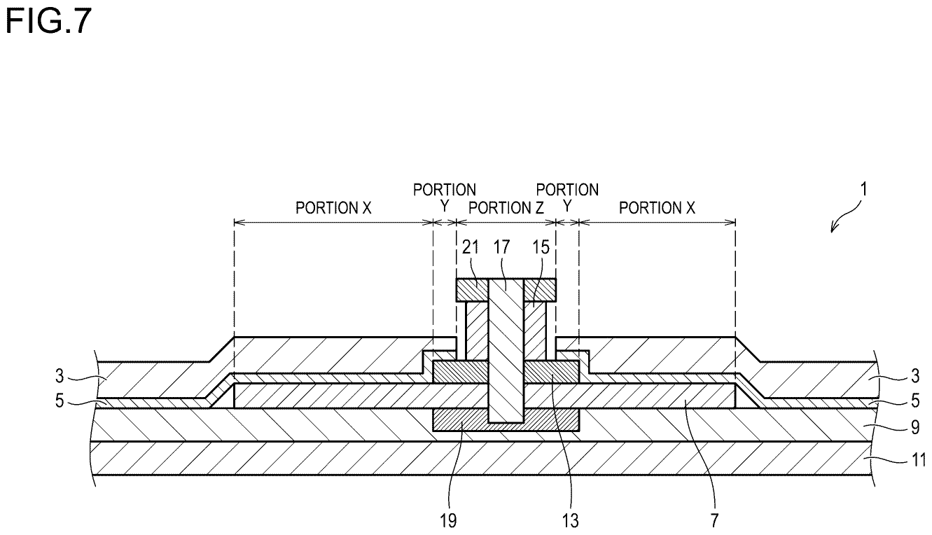

As shown in FIG. 7, preferably, the sheet-shaped heater 1 of the invention has the second joining auxiliary layer 19 between the heat-generating layer 7 and the second adhesion layer 9, at least a part of which is present within the portion Z, and also has at least a part of (and preferably the whole of) the third joining auxiliary layer 21 at a portion of the electrode 15 which is within the portion Z and is not in contact with the first joining auxiliary layer 13.

As in FIG. 2, FIG. 7 is a cross-sectional view of the sheet-shaped heater 1 of the invention in a direction perpendicular to its main surface.

In this preferred embodiment, the joining portion 17 is made up of at least a part of each of the second joining auxiliary layer 19, the heat-generating layer 7, the first joining auxiliary layer 13, the electrode 15, and the third joining auxiliary layer 21. Specifically, at least a part of each of the second joining auxiliary layer 19, the heat-generating layer 7, the first joining auxiliary layer 13, the electrode 15, and the third joining auxiliary layer 21 is preferably melted by heating and then solidified to form the joining portion 17. The joining portion 17 may be made up of at least a part of still another layer in addition to the above.

In this preferred embodiment, at least a part of each of the second joining auxiliary layer 19, the heat-generating layer 7, the first joining auxiliary layer 13, the electrode 15, and the third joining auxiliary layer 21 is more preferably melted simultaneously by heating and then solidified to form the joining portion 17.

In this case, the electrode 15 can be strongly bonded to the first joining auxiliary layer 13.

The sheet-shaped heater 1 of the invention in the embodiment shown in FIG. 7 preferably satisfies α>β₂ where α is the thickness of the first adhesion layer 5 and β₂ is the total thickness of the first joining auxiliary layer 13, the heat-generating layer 7, and the second joining auxiliary layer 19.

This is because, in this case, the first insulating layer 3 is closely attached to the heat-generating layer 7 through the first adhesion layer 5 over a wider area to further increase the insulation properties of the sheet-shaped heater 1 of the invention as a whole.

Next, each layer will be described in detail.

The first insulating layer 3 and the second insulating layer 11 will be described.

When the sheet-shaped heater 1 of the invention is set, the first insulating layer 3 and the second insulating layer 11 have a main role in insulating an object to be heated from the heat-generating layer 7.

The material and the thickness of the first insulating layer 3 may be the same as or different from those of the second insulating layer 11.

The first insulating layer 3 and the second insulating layer 11 may be made of, for example, PET (polyethylene terephthalate), PI (polyimide), PP (polypropylene), PE (polyethylene), PEN (polyethylene naphthalate), TAC (triacetyl cellulose), silicone resin, or ceramic, because they have high insulation properties. Among others, the first insulating layer 3 and the second insulating layer 11 made of PI (polyimide) can be preferably used because their insulation properties and heat resistance are excellent.

The thickness of each of the first insulating layer 3 and the second insulating layer 11 is not particularly limited, and is preferably 5 to 100 μm, more preferably 10 to 75 μm, and even more preferably 20 to 55 μm.

There is no particular limitation on the shapes and sizes of the first insulating layer 3 and the second insulating layer 11. However, the first insulating layer 3 and the second insulating layer 11 play a role in electrically insulating the heat-generating layer 7 and an object to be heated from each other and therefore the size of the main surface of each insulating layer is in general the same as or larger than that of the main surface of the heat-generating layer 7.

The first adhesion layer 5 and the second adhesion layer 9 will be described.

The material and the thickness of the first adhesion layer 5 may be the same as or different from those of the second adhesion layer 9.

The first adhesion layer 5 can be formed by, for example, applying an adhesive to a main surface of the first insulating layer 3. Likewise, the second adhesion layer 9 can be formed by, for example, applying an adhesive to a main surface of the second insulating layer 11.

Examples of the adhesive that may be used include acrylic adhesive, silicone adhesive, and rubber elastomer such as NBR. Both a thermosetting type and a thermoplastic type may be used for the adhesive.

An adhesive sheet can be used for the first adhesion layer 5 and the second adhesion layer 9. The adhesive sheet may be a sheet made of the same material as the above-mentioned adhesive.

Adhesive sheets stacked on top of each other may also be used for the first adhesion layer 5 or the second adhesion layer 9.

The thickness of the first adhesion layer 5 is not particularly limited, and is preferably 25 to 150 μm, more preferably 50 to 100 μm, and even more preferably 65 to 85 μm.

When adhesive sheets stacked on top of each other are used for the first adhesion layer 5, the total thickness thereof is taken as the thickness of the first adhesion layer 5.

The thickness of the second adhesion layer 9 is not particularly limited, and is preferably 5 to 120 μm, more preferably 10 to 75 μm, and even more preferably 15 to 40 μm.

When adhesive sheets stacked on top of each other are used for the second adhesion layer 9, the total thickness thereof is taken as the thickness of the second adhesion layer 9.

The heat-generating layer 7 will be described.

The heat-generating layer 7 need only be in the shape of a sheet which generates heat by energization.

The material of the heat-generating layer 7 is preferably, for example, stainless steel (e.g., SUS304, SUS316, or SUS316L) but may be Cu (copper), Al (aluminum), Ni (nickel), Nichrome, or carbon.

The heat-generating layer 7 is preferably composed of a fibrous material. For example, metal mesh sheet formed by arranging linear fibers in a sheet shape in directions approximately perpendicular to each other, metal fiber non-woven fabric formed by randomly arranging metal fibers, metal fiber woven fabric, metal fiber yarn, or metal fiber tape may be used.

Examples of the metal mesh sheet include 200 to 500-mesh metal mesh sheets.

An example of the metal fiber non-woven fabric is 1,500 g/m²-stainless steel fiber non-woven fabric (SUS316L needle punched web manufactured by Nikko Techno, Ltd.) .

An example of the metal fiber woven fabric is SUS cloth (Naslon Cloth A manufactured by Nippon Seisen Co., Ltd.).

An example of the metal fiber yarn is filament yarn (Naslon 12-2000/3 manufactured by Nippon Seisen Co., Ltd.).

An example of the metal fiber tape is SUS tape (Naslon Tape B W16 (manufactured by Nippon Seisen Co., Ltd.).

The thickness of the heat-generating layer 7 is preferably 10 to 600 μm, more preferably 20 to 150 μm, and even more preferably 25 to 50 μm. By setting the thickness of the heat-generating layer 7 as defined above, the sheet-shaped heater 1 of the invention can ensure the flexibility while also ensuring joining strength of the heat-generating layer 7, the first joining auxiliary layer 13, and the electrode 15.

The shape and size of the heat-generating layer 7 can be appropriately adjusted according to the shape and size of an object to be heated.

The heat-generating layer 7 preferably has a specific electrical resistance of 5 to 3,000 μΩcm and more preferably 10 to 2,500 μΩcm.

A value determined according to JIS K 7194 is taken as the specific electrical resistance of the heat-generating layer 7.

The heat-generating layer 7 is preferably primarily composed of metal fibers and more preferably only composed of metal fibers.

The term “primarily” means that the content is 70 mass % or more. In other words, the heat-generating layer 7 preferably contains metal fibers in an amount of 70 mass % or more. The heat-generating layer 7 contains metal fibers at a ratio of more preferably 80 mass % or more, even more preferably 90 mass % or more, and still more preferably 95 mass % or more.

The expression “only composed of metal fibers” means that the metal fiber content is 98 mass % or more.

The heat-generating layer 7 can sufficiently exhibit electric continuity and heat generation by setting the metal fiber content of the heat-generating layer 7 as defined above.

The metal fiber content in the heat-generating layer 7 is determined by the following method:

A surface of the heat-generating layer 7 is magnified at 1,000× using an EDS-scanning electron microscope (SEM-EDS) and subjected to EDS elemental analysis to specify the type of metal fibers; then the area of the metal fibers (except voids) within a field of view of 90 μm×120 μm is measured on an SEM image using an image processor and is raised to the three-halves power to be converted to volume ratio, which is further multiplied by the absolute specific gravity of the metal fibers to determine the mass ratio, thereby calculating the metal fiber content.

When two or more types of metal fibers are contained, the content is determined for each type of metal fibers and the total value is taken as the metal fiber content in the heat-generating layer 7.

The metal fibers are preferably those having a cross-sectional diameter in terms of equal-area circle equivalent diameter of 2 to 100 μm (preferably 5 to 20 μm) and a length of 2 to 20 mm.

A scanning electron microscope (SEM) is used to obtain an SEM image of metal fibers at 1,000×; thirty metal fiber cross-sections are arbitrarily selected on the image; the metal fiber cross-sectional area (cross-sectional area) is determined at each point and its simple average value is calculated; then the resulting average cross-sectional area is used to calculate the equal-area circle equivalent diameter of the metal fiber cross-sections.

The heat-generating layer 7 is preferably made of metal fiber non-woven fabric formed by randomly arranging such metal fibers (hereinafter referred to also as the metal fiber sheet). The metal fiber sheet may be only composed of metal fibers and contain voids but may contain, in addition to the metal fibers, materials other than the metal fibers (for example, resin fibers serving as a binder) as long as they do not impede heat generation.

Examples of the binder include carbon, glass, and silicone resin.

The metal fibers constituting the metal fiber sheet are preferably connected to each other at contact points to such an extent that at least energization is established. The metal fibers are more preferably fusion bonded to each other at their contact points by, for example, melting parts of the metal fibers through sintering at high temperatures and then solidifying.

The metal fiber sheet is preferably a stainless steel fiber sheet because of its high heat resistance and chemical resistance. An example of the stainless steel fiber sheet is a stainless steel fiber sheet (e.g., Tommy Filec SS manufactured by Tomoegawa Corporation).

The metal fiber sheet preferably has a basis weight of 25 g/m² or more, and preferably 50 g/m² or more. The basis weight is preferably 1,000 g/m² or less, and more preferably 200 g/m² or less.

When the basis weight of the metal fiber sheet has such a value, the strength of the metal fiber sheet can be ensured, and contact points between metal fibers can be comparatively made uniform. Therefore, the sheet-shaped heater 1 of the invention can ensure the flexibility while also ensuring joining strength of the heat-generating layer 7, the first joining auxiliary layer 13, and the electrode 15.

The basis weight is calculated by calculating the fiber volume per unit area of the metal fiber sheet through image observation using an optical microscope and determining the weight from the specific gravity.

The metal fiber sheet preferably has a density of 1.0 to 5.0 g/cm³, more preferably 1.4 to 2.0 g/cm³, and preferably around 1.7 g/cm³.

A value determined according to JIS P 8118 using formula: Density (g/cm³)=Basis weight (g/m²)/(Thickness (mm)×1,000) is taken as the density of the metal fiber sheet.

When the density of the metal fiber sheet is within such a range, the strength of the metal fiber sheet can be ensured, and contact points between metal fibers can be comparatively made uniform. Therefore, the joining strength of the heat-generating layer 7, the first joining auxiliary layer 13, and the electrode 15 can also be ensured.

The metal fiber sheet can be manufactured by both a dry non-woven fabric manufacturing process and a wet papermaking process. When it is manufactured by the wet papermaking process, for example, an infinite number of metal fibers which have a cross-sectional diameter of 2 to 100 μm in terms of equal-area circle equivalent diameter and a length of 2 to 20 mm are stirred in a dispersion medium (water, an organic solvent or the like) and an organic flocculant is then added; the mixture is formed into a sheet shape using a rectangular hand papermaking device (manufactured by Toyo Seiki Seisaku-sho, Ltd. or the like), and a dry sheet with a basis weight of 50 to 1,100 g/m² is obtained using a ferrotype drying device. Then, the dry sheet is burned at 400 to 1,300 °C, whereby a metal fiber sheet can be obtained.

The first joining auxiliary layer 13, the second joining auxiliary layer 19 and the third joining auxiliary layer 21 will be described.

The materials, the sizes and the thicknesses of the first joining auxiliary layer 13, the second joining auxiliary layer 19, and the third joining auxiliary layer 21 may be the same as or different from each other.

In a case where the second joining auxiliary layer 19 and/or the third joining auxiliary layer 21 is used in addition to the first joining auxiliary layer 13, they may be preferably made of the same material because in this case, the joining portion 17 that is to be formed is more likely to have higher strength.

The materials of the first joining auxiliary layer 13, the second joining auxiliary layer 19, and the third joining auxiliary layer 21 are not particularly limited as long as they have electrical conductivity. Cu (copper), Al (aluminum), Ni (nickel), Nichrome, carbon, Fe (iron), and Cr (chromium) may be used but stainless steel is particularly preferred. The material can be appropriately selected in consideration of the strength of joining to the electrode 15 and the heat-generating layer 7, the ease of joining, and the flexibility.

For example, metal foil, metal mesh sheet, metal fiber non-woven fabric, metal fiber woven fabric, metal fiber yarn, or metal fiber tape may be used for the first joining auxiliary layer 13, the second joining auxiliary layer 19, and the third joining auxiliary layer 21.

Examples of the metal mesh sheet include 200 to 500-mesh mesh sheets.

An example of the metal fiber non-woven fabric is 1,500 g/m²-stainless steel fiber non-woven fabric (SUS316L needle punched web manufactured by Nikko Techno, Ltd.).

An example of the metal fiber woven fabric is SUS cloth (Naslon Cloth A manufactured by Nippon Seisen Co., Ltd.).

An example of the metal fiber yarn is filament yarn (Naslon 12-2000/3 manufactured by Nippon Seisen Co., Ltd.).

An example of the metal fiber tape is SUS tape (Naslon Tape B W16 (manufactured by Nippon Seisen Co., Ltd.).

The first joining auxiliary layer 13, the second joining auxiliary layer 19, and the third joining auxiliary layer 21 are preferably made of metal foil and more preferably stainless steel foil. Metal foil facilitates joining to the electrode 15 and the heat-generating layer 7 by welding.

In a case where the materials of the electrode 15 and the heat-generating layer 7 are stainless steel, the joining portion 17 can be easily formed by using the first joining auxiliary layer 13, the second joining auxiliary layer 19, or the third joining auxiliary layer 21 also made of stainless steel. This effect is enhanced when they are made of stainless steel of the same composition.

The effect of facilitating joining by welding and the effect of easily forming the joining portion 17 can be simultaneously obtained by using stainless steel foil for the first joining auxiliary layer 13, the second joining auxiliary layer 19, and the third joining auxiliary layer 21. In this case, even when the joining portion 17 is small in size, the flexibility of the sheet-shaped heater 1 of the invention can be ensured while also ensuring the joining strength of the second joining auxiliary layer 19, the heat-generating layer 7, the first joining auxiliary layer 13, the electrode 15, and the third joining auxiliary layer 21.

For example, in a case where the electrode 15 and the heat-generating layer 7 are made of copper and stainless steel, respectively, the first joining auxiliary layer 13, the second joining auxiliary layer 19, or the third joining auxiliary layer 21 is preferably made of a nickel alloy.

The shapes and sizes of the first joining auxiliary layer 13, the second joining auxiliary layer 19, and the third joining auxiliary layer 21 can be appropriately adjusted but a main surface of each joining auxiliary layer facing the electrode 15 preferably has a larger area than a main surface of the electrode 15 facing the first joining auxiliary layer 13.

The first joining auxiliary layer 13, the second joining auxiliary layer 19, and the third joining auxiliary layer 21 preferably have a specific electrical resistance of 5 to 100 μΩcm, and more preferably 10 to 90 μΩcm.

A value determined according to JIS K 7194 is taken as the specific electrical resistance of the joining auxiliary material 3.

The thickness of each of the first joining auxiliary layer 13, the second joining auxiliary layer 19, and the third joining auxiliary layer 21 is preferably 1 to 60 μm, more preferably 3 to 35 μm, and even more preferably 5 to 15 μm. By setting the thickness as defined above, the sheet-shaped heater 1 of the invention can ensure the flexibility while also ensuring the joining strength of the heat-generating layer 7, the first joining auxiliary layer 13, and the electrode 15.

The electrode 15 will be described.

The electrode 15 can be connected to an external power source and need only be of a type in which electricity from the external power source can be supplied to the heat-generating

The material of the electrode 15 is not particularly limited. Cu (copper), Ag (silver), or Au (gold) may be used but stainless steel (for example, SUS304, SUS316, or SUS316L) is particularly preferred.

As for the structure of the electrode 15, for example, metal foil, metal mesh sheet formed by arranging linear fibers in a sheet shape in directions approximately perpendicular to each other, metal fiber non-woven fabric formed by randomly arranging metal fibers, metal fiber woven fabric, metal fiber yarn, or metal fiber tape may be used.

Examples of the metal mesh sheet include 200 to 500-mesh metal mesh sheets.

An example of the metal fiber non-woven fabric is 1,500 g/m²-stainless steel fiber non-woven fabric (SUS316L needle punched web manufactured by Nikko Techno, Ltd.).

An example of the metal fiber woven fabric is SUS cloth (Naslon Cloth A manufactured by Nippon Seisen Co., Ltd.).

An example of the metal fiber yarn is filament yarn (Naslon 12-2000/3 manufactured by Nippon Seisen Co., Ltd.).

An example of the metal fiber tape is SUS tape (Naslon Tape B W16 (manufactured by Nippon Seisen Co., Ltd.).

The electrode 15 includes a connecting portion (not shown) to the external power source and is configured to allow application of electric current from the external power source to the heat-generating layer 7. For example, the external power source may be connected to the electrode 15 by a cable using a crimp terminal.

The shape and the size of the electrode 15 can be appropriately adjusted as long as the connecting portion to the external power source can be disposed and electric current can be sufficiently applied to the heat-generating layer 7.

The electrode 15 preferably has a specific electrical resistance of 5 to 100 μΩcm and more preferably 10 to 90 μΩcm.

The specific electrical resistance of the electrode 15 is represented by a value calculated by the calculation formula: “Specific electrical resistance=1/Electrical conductivity” by reference to the electrical conductivity obtained from the elemental composition after the electrode 15 is subjected to XRD analysis to determine its constituent composition.

The electrode 15 is preferably composed of a fibrous material, and more preferably woven fabric made of metal fiber twisted thread or metal fiber woven fabric.

If woven fabric made of metal fiber twisted thread or metal fiber woven fabric is used, even when an external force is applied to the heater, the joining portion is less likely to be detached from the heat-generating layer 7 and the electrode because of the proper flexibility and strength.

Fibers other than metal fibers may be used as the constituent element of the woven fabric made of metal fiber twisted thread and the metal fiber woven fabric but they are preferably primarily composed of metal fibers and more preferably only composed of metal fibers.

The term “primarily” means that the content is 70 mass % or more. In other words, the electrode 15 contains metal fibers in an amount of preferably 70 mass % or more, more preferably 80 mass % or more, even more preferably 90 mass % or more, and still more preferably 95 mass % or more. The expression “only composed of metal fibers” means that the metal fiber content is 98 mass % or more.

The woven fabric made of metal fiber twisted thread and the metal fiber woven fabric may be in a state containing voids but may also contain fibers other than metal fibers (for example, resin fibers serving as a binder).

The metal fibers constituting the woven fabric made of metal fiber twisted thread and the metal fiber woven fabric are preferably those having a cross-sectional diameter in terms of equal-area circle equivalent diameter of 1 to 50 μm (preferably 2 to 30 μm).

A scanning electron microscope (SEM) is used to obtain an SEM image of the electrode 15 at 1,000×; thirty metal fiber cross-sections are arbitrarily selected on the image; the metal fiber cross-sectional area (cross-sectional area) is determined at each point and its simple average value is calculated; then the resulting average cross-sectional area is used to calculate the equal-area circle equivalent diameter of the metal fiber cross-sections.

By setting the equal-area circle equivalent diameter of the metal fiber cross-sections as defined above, the sheet-shaped heater 1 of the invention can ensure the flexibility while also ensuring the joining strength of the heat-generating layer 7, the first joining auxiliary layer 13, and the electrode 15.

The electrode 15 preferably has a thickness of 0.5 to 3 mm. By setting the thickness as defined above, the sheet-shaped heater 1 of the invention ensures the flexibility while also easily ensuring the joining strength of the heat-generating layer 7, the first joining auxiliary layer 13, and the electrode 15.

The sheet-shaped heater 1 of the invention may also include other layers and a sheet-shaped base material which do not correspond to the first insulating layer 3, the first adhesion layer 5, the first joining auxiliary layer 13, the heat-generating layer 7, the second adhesion layer 9, the second insulating layer 11, the electrode 15, the second joining auxiliary layer 19, and the second joining auxiliary layer 19 as described above.

For example, the sheet-shaped heater may have a sheet-shaped base material through an adhesive layer on a main surface of the second insulating layer 11 which is not in contact with the second adhesion layer 9. The adhesive layer may be the same type as the first adhesion layer 5 or the second adhesion layer 9.

The sheet-shaped base material is preferably made of a material having insulation properties and flexibility, as exemplified by PET (polyethylene terephthalate), PI (polyimide), PP (polypropylene), PE (polyethylene), PEN (polyethylene naphthalate), and TAC (triacetyl cellulose).

The sheet-shaped base material may be made of fluororesin. Examples of the fluororesin include polytetrafluoroethylene (PTFE), vinylidene fluoride-hexafluoropropylene copolymer, and vinylidene fluoride-tetrafluoroethylene-hexafluoropropylene copolymer.

Further, the sheet-shaped base material may be a high-strength/high-insulation sheet obtained by impregnating reinforced fibers such as glass, aramid (aromatic polyamide resin) and carbon fiber with fluororesin.

The thickness of the sheet-shaped base material is not particularly limited, and is preferably 15 to 100 μm, more preferably 30 to 75 μm, and even more preferably about 50 μm.

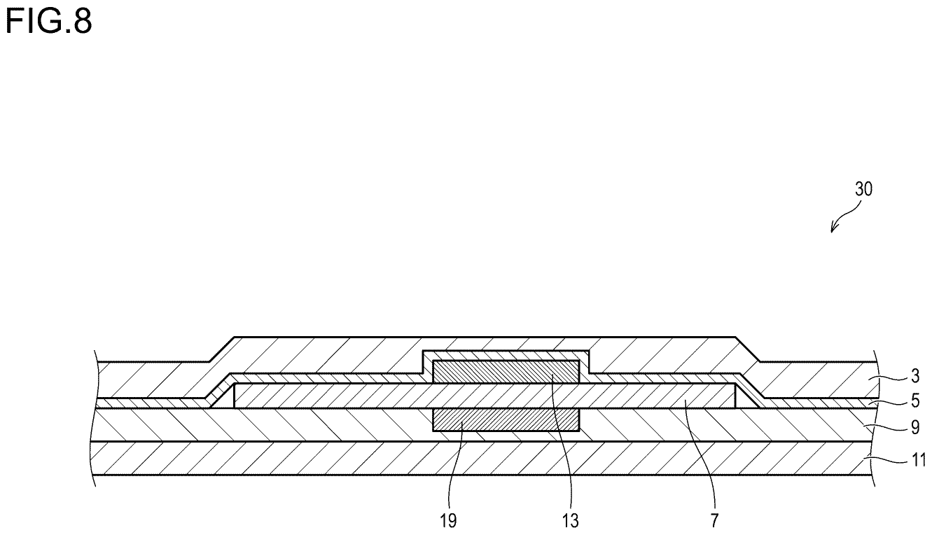

The method of manufacturing the sheet-shaped heater 1 of the invention will be described using FIG. 8 to FIG. 13.

As in FIG. 2, FIG. 8 to FIG. 13 are cross-sectional views of the sheet-shaped heater 1 of the invention in a direction perpendicular to its main surface.

The method of manufacturing the sheet-shaped heater 1 of the invention is not particularly limited, and the sheet-shaped heater 1 is preferably manufactured by the method to be described below.

A method of manufacturing the sheet-shaped heater 1 of the invention in the embodiment shown in FIG. 7 including the second joining auxiliary layer 19 and the third joining auxiliary layer 21 will be described below but even the sheet-shaped heaters 1 of the invention according to the embodiments in FIGS. 2, 4 and 6 which do not include at least one of these layers can also be manufactured.

First, the second insulating layer 11, the second adhesion layer 9, the second joining auxiliary layer 19, the heat-generating layer 7, the first joining auxiliary layer 13, the first adhesion layer 5, and the first insulating layer 3 are stacked in this order to form a sheet 30 in an embodiment shown in FIG. 8.

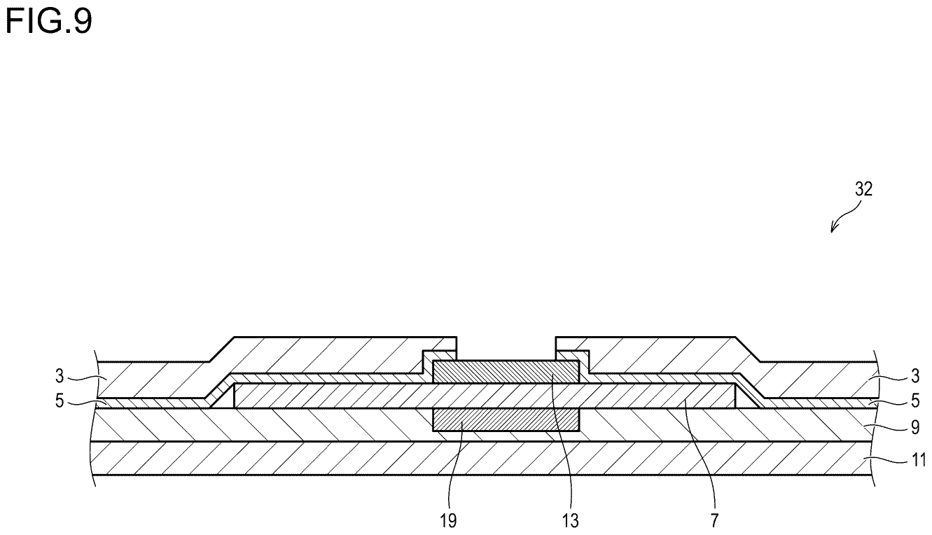

Next, parts of the first insulating layer 3 and the first adhesion layer 5 are cut out using a box cutter or the like so that a part of a surface of the first joining auxiliary layer 13 in the sheet 30 is exposed, thereby obtaining a sheet 32 in an embodiment shown in FIG. 9.

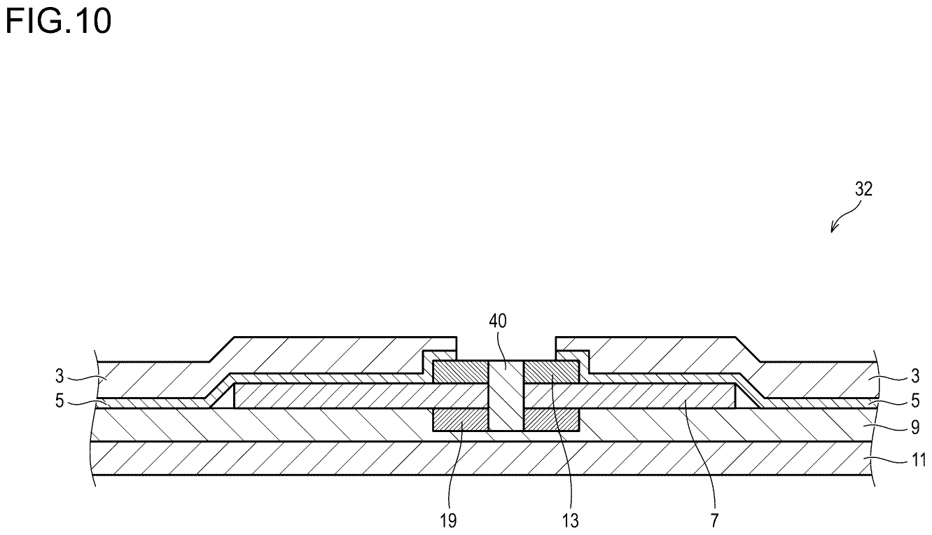

Then, a welding pen is pressed onto the first joining auxiliary layer 13 to perform spot welding. Then, at least a part of each of the second joining auxiliary layer 19, the heat-generating layer 7, and the first joining auxiliary layer 13 is melted simultaneously. Then, the melt is solidified to form a joining precursor 40 as shown in FIG. 10.

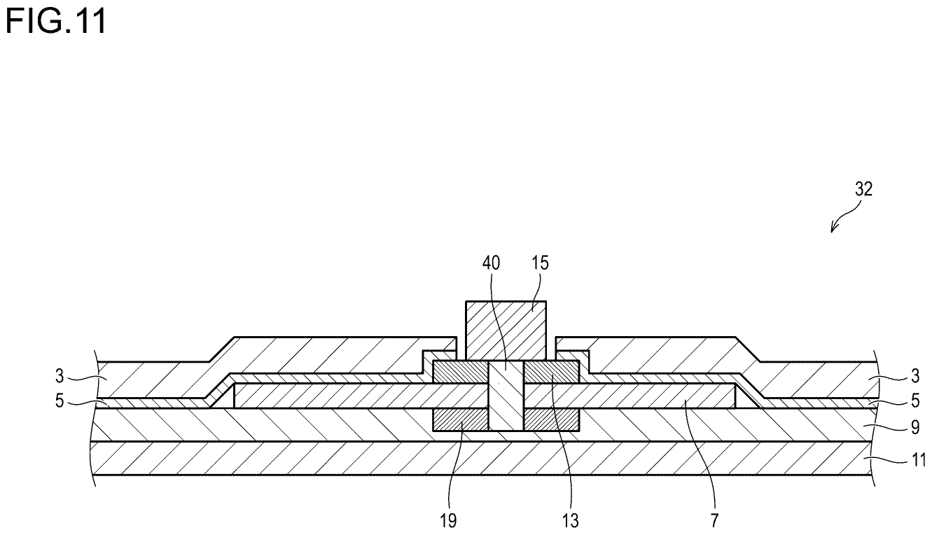

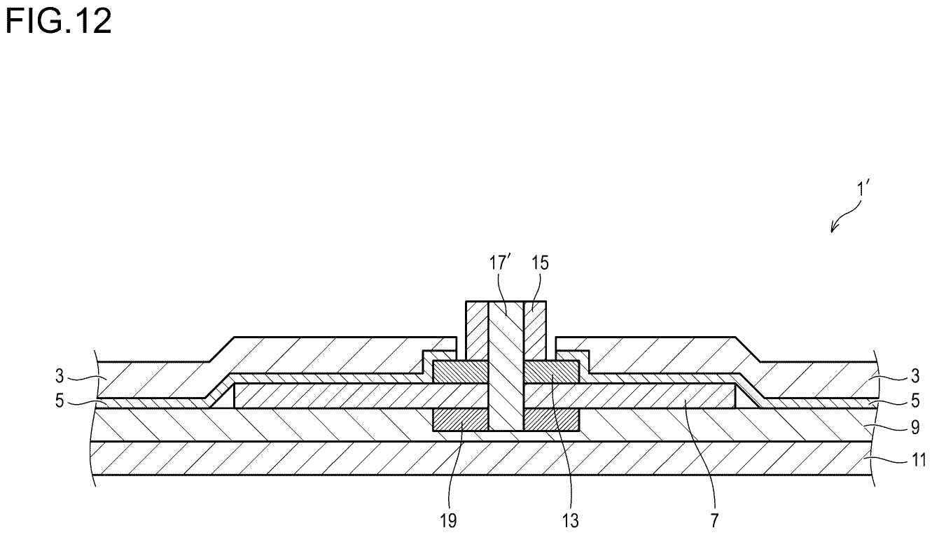

Next, as shown in FIG. 11, the electrode 15 is disposed on the upper surface of the first joining auxiliary layer 13 in the sheet 32. Then, the welding pen is pressed onto the electrode 15 to perform spot welding. Then, at least a part of each of the joining precursor 40 and/or the first joining auxiliary layer 13 and the electrode 15 is melted simultaneously. In addition to the joining precursor 40 and/or the first joining auxiliary layer 13 and the electrode 15, at least a part of each of the second joining auxiliary layer 19 and/or the heat-generating layer 7 is preferably further melted simultaneously. Then, the melt is solidified to form a joining portion 17′ as shown in FIG. 12.

A sheet obtained here corresponds to the sheet-shaped heater of the invention. Specifically, it corresponds to the sheet-shaped heater of the invention shown in FIG. 4. This heater is referred to as a sheet-shaped heater 1′ of the invention.

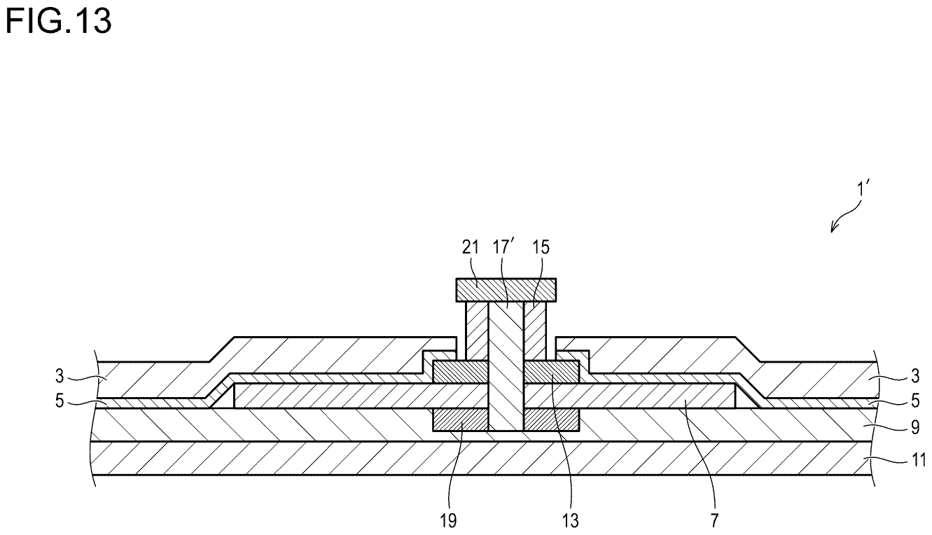

Next, as shown in FIG. 13, the third joining auxiliary layer 21 is disposed on the electrode 15. Then, the welding pen is pressed onto the third joining auxiliary layer 21 to perform spot welding. Then, at least a part of each of the joining portion 17′ and/or the electrode 15, and the third joining auxiliary layer 21 is melted simultaneously. In addition to the joining portion 17′ and/or the electrode 15 and the third joining auxiliary layer 21, a part of at least one selected from the group consisting of the first joining auxiliary layer 13, the heat-generating layer 7, and the second joining auxiliary layer 19 is preferably further melted simultaneously. Then, the melt is solidified to form the joining portion 17 as shown in FIG. 7.

The sheet-shaped heater 1 of the invention in the embodiment shown in FIG. 7 can be thus obtained.

The method of manufacturing the sheet-shaped heater 1 of the invention described using FIG. 8 to FIG. 13 is hereinafter referred to also as the “manufacturing method of the invention.”

The manufacturing method of the invention is a manufacturing method including a welding step for forming the joining precursor 40 but the sheet-shaped heater of the invention may also be manufactured without forming the joining precursor 40. For instance, the sheet-shaped heater of the invention in the embodiment shown in FIG. 7 can also be manufactured by the method which includes: disposing the electrode 15 on the upper surface of the first joining auxiliary layer 13 in the sheet 32 shown in FIG. 9; further disposing the third joining auxiliary layer 21 thereon; and then pressing a welding pen onto the third joining auxiliary layer 21 to perform spot welding.

In the sheet-shaped heater of the invention as described above, electricity supplied from the external power source passes through the joining portions 17 and 17′ via the electrode 15 to reach the heat-generating layer 7. Then, the heat-generating layer 7 generates heat to heat an object to be heated.

The object to be heated is not particularly limited and may be, for example, piping. Piping has curved surfaces and therefore when a sheet-shaped heater is attached thereto, the adhesion of the insulating layer to the heat-generating layer generally tends to be reduced. In contrast, in the sheet-shaped heater of the invention, the insulating layer is closely attached to the heat-generating layer through the adhesion layer over a wide area even when the object to be heated is piping.

EXAMPLES The last operation in the manufacturing method of the invention, that is, the operation described using in FIG. 13 in which treatment is performed after the third joining auxiliary layer 21 is disposed on the electrode 15 was not performed but the preceding operations (operations described using FIG. 8 to FIG. 12) were performed to form the sheet-shaped heater 1 of the invention shown in FIG. 4. Then, to the second insulating layer 11 of the resulting sheet-shaped heater of the invention shown in FIG. 4, a sheet-shaped base material was attached through an adhesive layer to form a sheet-shaped heater.

Specifically, each layer is as follows:
First insulating layer and second insulating layer: Polyimide film, thickness: 25 μm;
First adhesion layer: Fluorine adhesive layer, three films with a thickness of 25 μm are stacked on top of each other (total thickness: 75 μm);
Second adhesion layer: Fluorine adhesive layer, thickness: 25 μm;
Heat-generating layer: Stainless steel paper (Tommy Filec SS manufactured by Tomoegawa Corporation), thickness: 30 μm;
First joining auxiliary layer and second joining auxiliary layer: Stainless steel foil (SUS-316L), thickness: 10 μm, having slits shown in FIG. 3B;
Adhesive layer: Fluorine adhesive layer, 25 μm;
Sheet-shaped base material: High-strength/high-insulation sheet obtained by impregnating glass cloth with PTFE (PTFE cloth) (FGF-500-8 manufactured by Chukoh Chemical Industries, Ltd.), thickness: 170 μm.

The fluorine adhesive used to form the first adhesion layer, the second adhesion layer, and the adhesive layer is the one in which the solubility obtained by performing a solvent solubility test is within a range of 5 to 30 mass %. The solvent solubility test is a test which includes: putting 1,000 g of tetrahydrofuran (THF) into a 2 L polyethylene bottle; adjusting its temperature to 23 °C; putting 1 to 50 g of a granular sample (adhesive a) with a diameter of 0.5 to 2.0 cm into the tetrahydrofuran being stirred at 600 rpm by a medium viscosity agitator (high power, general-purpose agitator BLH1200 manufactured by Shinto Scientific Co., Ltd.) using a Disper blade with a blade diameter of 40 mm as the stirrer blade; checking whether the total amount of the sample is dissolved after the passage of 24 hours; additionally putting 1 to 50 g of the sample (adhesive α) again if it is dissolved; and repeating the process for checking whether it is dissolved after the passage of 24 hours, thereby determining the maximum soluble amount (solubility).

The fluorine adhesive used to form the first adhesion layer, the second adhesion layer, and the adhesive layer has a fluorine content of 57 to 60 mass %. The fluorine content means a value obtained by the method according to JIS K 7217 (Analytical Method for Determining Gases Evolved from Burning Plastics) which includes: absorbing fluororesin combustion gas into an absorbing liquid; and performing a quantitative analysis according to JIS K 0102 34.1.

The fluorine adhesive used to form the first adhesion layer, the second adhesion layer, and the adhesive layer has an unsaturated bond content of 0.1 to 10%. The unsaturated bond content is calculated by the ratio between the accumulated amount at peaks (4.5 to 6.0 ppm) derived from alkyl chain unsaturated bond-related hydrogen and that at peaks derived from saturated bond-related hydrogen in a spectrum obtained by ¹H-NMR (solid-state NMR) measurement.

The fluorine adhesive used to form the first adhesion layer, the second adhesion layer, and the adhesive layer has a storage modulus at 25 °C (E₁) of 5.58 MPa. An adhesive layer with a thickness of 400 μm is used to measure the storage modulus with a dynamic thermoelasticity measuring device at a measurement frequency of 10 Hz while increasing the measurement temperature from 0 °C to 120 °C at 3 °C/min, and a value obtained at 25 °C is taken as the storage modulus at 25 °C (E₁) of the adhesive.

The fluorine adhesive used to form the first adhesion layer, the second adhesion layer, and the adhesive layer has a storage modulus at 70 °C (E₂) of 3 MPa. An adhesive layer with a thickness of 400 μm is used to measure the storage modulus with a dynamic thermoelasticity measuring device at a measurement frequency of 10 Hz while increasing the measurement temperature from 0 °C to 120 °C at 3 °C/min, and a value obtained at 70 °C is taken as the storage modulus at 70 °C (E₂) of the adhesive.

In the resulting sheet-shaped heater, the first insulating layer 3 was closely attached to the heat-generating layer 7 through the first adhesion layer 5 and neither floating nor delamination occurred.

Even when the resulting sheet-shaped heater was disposed so as to be closely attached to a lateral surface of cylindrical piping with a diameter of 27 mm, the first insulating layer 3 was closely attached to the heat-generating layer 7 through the first adhesion layer 5 and tunneling did not occur. Therefore, it can be said that the sheet-shaped heater obtained here has high insulation properties as a whole.

Other inventions similar to the present invention will be described.

As in the sheet-shaped heater of the invention, the following invention (I) provides a sheet-shaped heater including an insulating layer closely attached to a heat-generating layer through an adhesion layer over a wide area and hence having high insulation properties as a whole.

The invention (I) provides a sheet-shaped heater including:
a portion X in which
a first insulating layer,
a first adhesion layer,
a heat-generating layer,
a second adhesion layer, and
a second insulating layer
   are stacked in this order;
a portion Y which is present inside the portion X so as to be adjacent to the portion X when a main surface is seen from its perpendicular line direction, and in which
the first insulating layer,
the first adhesion layer,
a first joining auxiliary layer,
the heat-generating layer,
the second adhesion layer, and
the second insulating layer
   are stacked in this order; and
a portion Z which is present inside the portion Y so as to be adjacent to the portion Y when the main surface is further seen from its perpendicular line direction, in which
the first joining auxiliary layer,
the heat-generating layer,
the second adhesion layer, and
the second insulating layer
   are stacked in this order, and which does not include the first insulating layer or the first adhesion layer, wherein:
the first insulating layer at the portion X and the portion Y is an integral part,
the first joining auxiliary layer at the portion Y and the portion Z is an integral part,
each of the heat-generating layer and the second insulating layer at the portion X, the portion Y, and the portion Z is an integral part,
an electrode is present on a main surface of the first joining auxiliary layer which is on a side farther away from the heat-generating layer,
the sheet-shaped heater has a joining portion made up of at least a part of each of the heat-generating layer, the first joining auxiliary layer, and the electrode (preferably a joining portion formed by melting at least a part of each of the heat-generating layer, the first joining auxiliary layer, and the electrode through heating and then solidifying), and the joining portion electrically connects the heat-generating layer, the first joining auxiliary layer and the electrode to each other, and
the sheet-shaped heater satisfies α>β₁ where α is a thickness of the first adhesion layer and β₁ is a total thickness of the first joining auxiliary layer and the heat-generating layer.

As in the sheet-shaped heater of the invention, the following invention (II) provides a sheet-shaped heater including an insulating layer closely attached to a heat-generating layer through an adhesion layer over a wide area and hence having high insulation properties as a whole.

The invention (II) provides a sheet-shaped heater including:
a portion X in which
a first insulating layer,
a first adhesion layer,
a heat-generating layer,
a second adhesion layer, and
a second insulating layer
   are stacked in this order;
a portion Y which is present inside the portion X so as to be adjacent to the portion X when a main surface is seen from its perpendicular line direction, and in which
the first insulating layer,
the first adhesion layer,
a first joining auxiliary layer,
the heat-generating layer,
the second adhesion layer, and
the second insulating layer
   are stacked in this order; and
a portion Z which is present inside the portion Y so as to be adjacent to the portion Y when the main surface is further seen from its perpendicular line direction, in which
the first joining auxiliary layer,
the heat-generating layer,
the second adhesion layer, and
the second insulating layer
   are stacked in this order, and which does not include the first insulating layer or the first adhesion layer, wherein:
the first insulating layer at the portion X and the portion Y is an integral part,
the first joining auxiliary layer at the portion Y and the portion Z is an integral part,
each of the heat-generating layer and the second insulating layer at the portion X, the portion Y, and the portion Z is an integral part,
an electrode is present on a main surface of the first joining auxiliary layer which is on a side farther away from the heat-generating layer,
the sheet-shaped heater has a second joining auxiliary layer, at least a part thereof being present within the portion Z between the heat-generating layer and the second adhesion layer,
the sheet-shaped heater has a joining portion made up of at least a part of each of the second joining auxiliary layer, the heat-generating layer, the first joining auxiliary layer, and the electrode (preferably a joining portion formed by melting at least a part of each of the second joining auxiliary portion, the heat-generating layer, the first joining auxiliary layer, and the electrode through heating and then solidifying), and the joining portion electrically connects the second joining auxiliary portion, the heat-generating layer, the first joining auxiliary layer and the electrode to each other, and
the sheet-shaped heater satisfies α>β₂ where α is a thickness of the first adhesion layer and β₂ is a total thickness of the first joining auxiliary layer, the heat-generating layer, and the second joining auxiliary layer.

As described above, in the sheet-shaped heater of the invention, the first joining auxiliary layer has slits, at least parts thereof being present within the portion Y and/or the portion Z. In contrast, the first joining auxiliary layers in the sheet-shaped heaters of the inventions (I) and (II) have no such slits. The former is different from the latter in this point and the other points are common to both.

This application claims priority based on Japanese Patent Application No. 2023-91715 filed on Jun. 2, 2023, the entire disclosure of which is incorporated herein by reference.

1. A sheet-shaped heater comprising:
a portion X in which
a first insulating layer,
a first adhesion layer,
a heat-generating layer,
a second adhesion layer, and
a second insulating layer
are stacked in this order;
a portion Y which is present inside the portion X so as to be adjacent to the portion X when a main surface is seen from its perpendicular line direction, and in which
the first insulating layer,
the first adhesion layer,
a first joining auxiliary layer,
the heat-generating layer,
the second adhesion layer, and
the second insulating layer
are stacked in this order; and
a portion Z which is present inside the portion Y so as to be adjacent to the portion Y when the main surface is further seen from its perpendicular line direction, in which
the first joining auxiliary layer,
the heat-generating layer,
the second adhesion layer, and
the second insulating layer
are stacked in this order, and which does not include the first insulating layer or the first adhesion layer, wherein:
the first insulating layer at the portion X and the portion Y is an integral part,
the first joining auxiliary layer at the portion Y and the portion Z is an integral part,
each of the heat-generating layer and the second insulating layer at the portion X, the portion Y, and the portion Z is an integral part,
an electrode is present on a main surface of the first joining auxiliary layer which is on a side farther away from the heat-generating layer,
the sheet-shaped heater has a joining portion made up of at least a part of each of the heat-generating layer, the first joining auxiliary layer, and the electrode, and the joining portion electrically connects the heat-generating layer, the first joining auxiliary layer and the electrode to each other, and
the first joining auxiliary layer has slits, at least parts thereof being present within the portion Y and/or the portion Z.

2. The sheet-shaped heater according to claim 1, satisfying α>β₁ where α is a thickness of the first adhesion layer and β₁ is a total thickness of the first joining auxiliary layer and the heat-generating layer.

3. The sheet-shaped heater according to claim 1, wherein at least a part of each of the heat-generating layer, the first joining auxiliary layer, and the electrode is melted by heating and then solidified to form the joining portion.

4. The sheet-shaped heater according to claim 1, further comprising:
a second joining auxiliary layer, at least a part thereof being present within the portion Z between the heat-generating layer and the second adhesion layer,
wherein the joining portion is made up of at least a part of each of the second joining auxiliary layer, the heat-generating layer, the first joining auxiliary layer, and the electrode.

5. The sheet-shaped heater according to claim 4, satisfying α>β₂ where α is a thickness of the first adhesion layer and β₂ is a total thickness of the first joining auxiliary layer, the heat-generating layer, and the second joining auxiliary layer.

6. The sheet-shaped heater according to claim 4, wherein at least a part of each of the second joining auxiliary layer, the heat-generating layer, the first joining auxiliary layer, and the electrode is melted by heating and then solidified to form the joining portion.

7. The sheet-shaped heater according to claim 1, further comprising:
at least a part of a third joining auxiliary layer coming into contact with a portion of the electrode which is within the portion Z and is not in contact with the first joining auxiliary layer,
wherein the joining portion is made up of at least a part of each of the heat-generating layer, the first joining auxiliary layer, the electrode, and the third joining auxiliary layer.

8. The sheet-shaped heater according to claim 7, satisfying α>β₁ where α is a thickness of the first adhesion layer and β₁ is a total thickness of the first joining auxiliary layer and the heat-generating layer.

9. The sheet-shaped heater according to claim 7, wherein at least a part of each of the heat-generating layer, the first joining auxiliary layer, the electrode, and the third joining auxiliary layer is melted by heating and then solidified to form the joining portion.

10. The sheet-shaped heater according to claim 4, further comprising:
at least a part of a third joining auxiliary layer coming into contact with a portion of the electrode which is within the portion Z and is not in contact with the first joining auxiliary layer,
wherein the joining portion is made up of at least a part of each of the second joining auxiliary layer, the heat-generating layer, the first joining auxiliary layer, the electrode, and the third joining auxiliary layer.

11. The sheet-shaped heater according to claim 10, satisfying α>β₂ where α is a thickness of the first adhesion layer and β₂ is a total thickness of the first joining auxiliary layer, the heat-generating layer, and the second joining auxiliary layer.

12. The sheet-shaped heater according to claim 10, wherein at least a part of each of the second joining auxiliary layer, the heat-generating layer, the first joining auxiliary layer, the electrode, and the third joining auxiliary layer is melted by heating and then solidified to form the joining portion.
